(19) United States
(12) Patent Application Publication
(10) Pub. No.: US 2025/0202245 A1
(43) Pub. Date: Jun. 19, 2025

(54) BATTERY CONTROL SYSTEM

(71) Applicant: Toyota Jidosha Kabushiki Kaisha, Toyota-shi (JP)

(72) Inventor: Kohei TAKATANI, Toyota-shi (JP)

(73) Assignee: Toyota Jidosha Kabushiki Kaisha, Toyota-shi (JP)

(21) Appl. No.: 18/971,633

(22) Filed: Dec. 6, 2024

(30) Foreign Application Priority Data
Dec. 15, 2023 (JP) 2023-212045

(51) Int. Cl. H02J 7/00; B60L 58/18

(52) U.S. Cl. CPC H02J 7/0013; H02J 7/007182; B60L 58/18; H02J 2207/20

(57) ABSTRACT

A battery control system for controlling charging by jump start of an auxiliary battery having a reduced power storage amount, the battery control system comprising: a first processing unit that determines whether the auxiliary battery is in a chargeable state; a second processing unit that adjusts an output voltage of the high-voltage battery when the auxiliary battery is in a chargeable state; and a third processing unit that causes the auxiliary battery to be charged by electric power of the high-voltage battery when the output voltage of the high-voltage battery becomes equal to or lower than a first threshold value.

### CROSS-REFERENCE TO RELATED APPLICATION

This application claims priority to Japanese Patent Application No. 2023-212045 filed on Dec. 15, 2023, incorporated herein by reference in its entirety.

### BACKGROUND

### 1. Technical Field

The present disclosure relates to a battery control system that controls charging/discharging of an auxiliary battery mounted in a vehicle.

### 2. Description of Related Art

Japanese Unexamined Patent Application Publication No. 2017-104000 (JP 2017-104000 A) discloses a power supply control system for a jump start, which is implemented when an auxiliary battery of a vehicle over-discharges to an extent that the vehicle cannot be started. In the power supply control system, three relays provided between a high-voltage battery, the auxiliary battery, and a jump start power supply connection terminal are appropriately controlled. JP 2017-104000 A describes that, in the power supply control system, charging of the auxiliary battery is performed with power of the high-voltage battery, without causing an overcurrent/overvoltage in the auxiliary battery.

### SUMMARY

In the power supply control system described in JP 2017-104000 A, it is not determined whether or not the auxiliary battery is in a chargeable state, before the auxiliary battery is charged. Accordingly, when the auxiliary battery is a lithium-ion battery, if charging is performed in a state where the auxiliary battery cannot be charged due to over-discharge, there is a possibility that copper eluted from a negative electrode at a time of over-discharge is precipitated, and a short circuit of the electrode occurs.

The present disclosure provides a battery control system that can suppress occurring of a short circuit of an electrode due to eluted copper when a jump start is performed with respect to an auxiliary battery in an over-discharge state.

In order to solve the problem, one aspect of the present disclosure technology is
a battery control system that controls charging by a jump start of an auxiliary battery in which a power storage amount is reduced, the battery control system including
a first processing unit that determines whether or not the auxiliary battery is in a chargeable state,
a second processing unit that adjusts an output voltage of a high-voltage battery when the auxiliary battery is in the chargeable state, and
a third processing unit that charges the auxiliary battery with power of the high-voltage battery when the output voltage of the high-voltage battery becomes equal to or less than a first threshold.

According to the battery control system of the present disclosure, when a jump start is performed with respect to an auxiliary battery in an over-discharged state, charging is performed when it is determined that the auxiliary battery is in a chargeable state. Accordingly, occurring of a short circuit of an electrode due to copper eluted in an auxiliary battery can be suppressed.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a functional block diagram of a battery control system and a peripheral portion thereof according to an embodiment of the present disclosure;

FIG. 2A is a flowchart illustrating a charge control (first example) process of an auxiliary battery executed by a battery control system;

FIG. 2B is a flowchart illustrating a charge control (first example) process of an auxiliary battery executed by a battery control system;

FIG. 3 is a flow chart for explaining a procedure of charge control (second example) of the auxiliary battery executed by the battery control system; and

FIG. 4 is a flowchart for explaining a procedure of charge control (third example) of an auxiliary battery executed by the battery control system.

### DETAILED DESCRIPTION OF EMBODIMENTS

The battery control system of the present disclosure confirms that the auxiliary battery is in a state in which the auxiliary battery may be recharged when the auxiliary battery starts up the vehicle at a jump start. Further, after the output voltage of the high-voltage battery 10 is adjusted to a voltage at which the auxiliary battery 31 does not become an overvoltage, the high-voltage battery 10 and the auxiliary battery 31 are relayed and connected to each other to charge the auxiliary battery 31 with the electric power of the high-voltage battery 10.

Hereinafter, an embodiment of the present disclosure will be described in detail with reference to the drawings.

### Embodiment

### Configuration

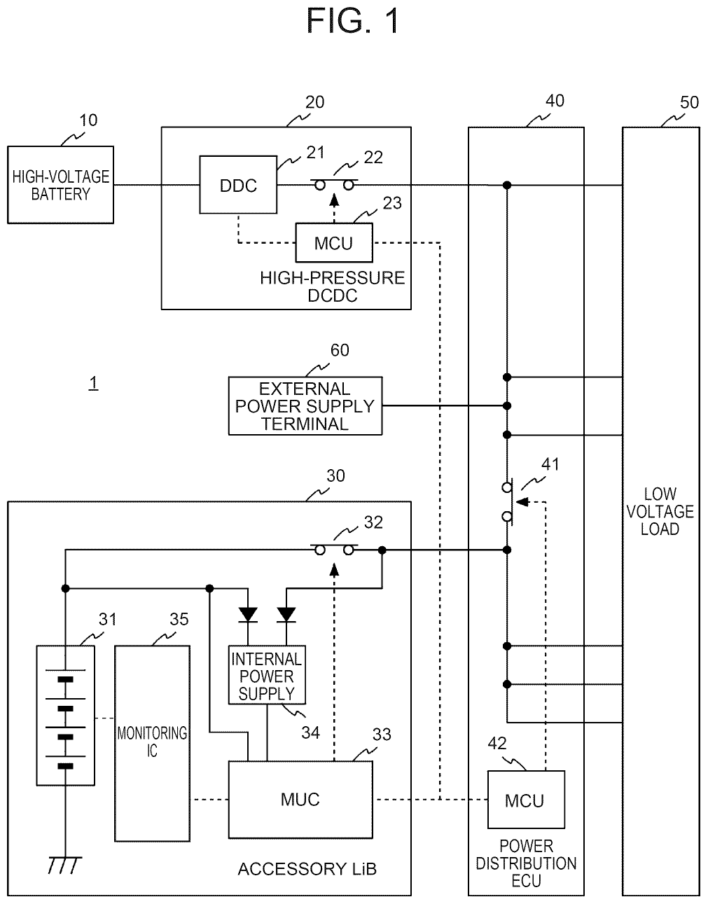

FIG. 1 is a functional block diagram of a battery control system 1 and a peripheral portion thereof according to an embodiment of the present disclosure. The battery control system 1 illustrated in FIG. 1 includes a high-voltage battery 10, a high-voltage DCDC 20, an auxiliary LiB 30, and a power distribution ECU 40. In FIG. 1, a power line through which power is transmitted and received is indicated by a solid line, and a signal line through which a detection value, a control instruction, a request, and the like flow is indicated by a broken line.

The configuration shown in FIG. 1 can be mounted on electrified vehicle such as hybrid electric vehicle (HEV), plug-in hybrid electric vehicle (PHEV), and battery electric vehicle (BEV).

The high-voltage battery 10 is a secondary battery configured to be chargeable and dischargeable, such as a lithium-ion battery. The high-voltage battery 10 is capable of supplying the electric power stored therein to the auxiliary LiB 30 and the low-voltage loads 50 via the high-voltage DCDC 20 and the power distribution ECU 40. In addition, the high-voltage battery 10 may store electric power output by a generator (not shown) such as an alternator. In electrified vehicle, for example, the driving battery corresponds to the high-voltage battery 10.

The high-voltage DCDC 20 is provided between the high-voltage battery 10 and the power distribution ECU 40. The high voltage of the inputted high-voltage battery 10 is converted into a low voltage required for the auxiliary LiB 30 and the low voltage loads 50, and outputted to the respective components via the power distribution ECU 40. The high-voltage DCDC 20 includes a DCDC converter (DDC) 21, a relay 22, and a MCU 23.

DCDC converter (DDC) 21 is configured to convert the output voltage of the high-voltage battery 10 into a desired voltage. The relay 22 is one configuration for switching between the high-voltage battery 10 and the auxiliary battery 31 of the auxiliary LiB 30 to be described later. MCU 23 is a unit for controlling the DCDC converter (DDC) 21 and the relay 22, and includes, for example, a microcomputer, a memory, and the like.

The auxiliary LiB 30 is a power source for supplying power to the low-voltage loads 50. The auxiliary LiB 30 includes an auxiliary battery 31, a relay 32, a MCU 33, an internal power supply 34, and a monitoring IC 35.

The auxiliary battery 31 is a secondary battery configured to be chargeable and dischargeable, such as a lithium-ion battery. The auxiliary battery 31 stores the electric power outputted from the high-voltage battery 10 via the high-voltage DCDC 20, and supplies the electric power stored by itself to the low-voltage loads 50 via the relay 32. As the auxiliary battery 31, a low-voltage (e.g., 12 V) battery is used. The relay 32 is one configuration for switching the electrical connection state (conduction/disconnection) between the high-voltage battery 10 and the auxiliary battery 31. The relay 32 is a relay, Low voltage Battery Protection Relay (LBPR) for protecting the auxiliary battery 31 which is a low-voltage battery. MCU 33 is a unit that controls the relay 32 and includes, for example, a microcomputer and memories. The internal power supply 34 is configured to convert a voltage (e.g., 12 V) of the auxiliary battery 31 or a voltage (e.g., 12 V) applied from another configuration to the auxiliary LiB 30 into a voltage (e.g., 5 V) required for driving MCU 33, and to output the converted voltage. For example, an LDO regulator is used as the internal power supply 34. The monitoring IC 35 is a configuration (battery management system) for constantly monitoring the status of the auxiliary battery 31. This monitoring IC 35 can acquire the status (voltage, current, temperature, etc.) of the auxiliary battery 31 using a sensor or the like.

The power distribution ECU 40 is a configuration Electronic Control Unit for distributing power supplied from the high-voltage battery 10 and the auxiliary battery 31 of the auxiliary LiB 30 to the low-voltage loads 50. The power distribution ECU 40 includes a relay 41 and MCU 42.

The relay 41 is one configuration for switching the electrical connection state (conduction/disconnection) between the high-voltage battery 10 and the auxiliary battery 31. MCU 42 is a unit that controls the relay 41 and includes, for example, a microcomputer and memories.

The low-voltage loads 50 are, for example, 12 V type in-vehicle devices (motors, ECU, and the like) that operate with low-voltage power stepped down in the high-voltage DCDC 20 supplied from the high-voltage battery 10 or low-voltage power supplied from the auxiliary battery 31.

The external power supply terminal 60 is a rescue terminal for connecting an external charger (not shown) when a vehicle that cannot be started due to a decrease in the power storage amount in the auxiliary battery 31 is jump started.

In the battery control system 1, the functions of the first processing unit, the second processing unit, and the third processing unit in the claims are realized by MCU 23 of the high-voltage DCDC 20, MCU 33 of the auxiliary LiB 30, and MCU 42 of the power 20 distribution ECU 40.

### Control

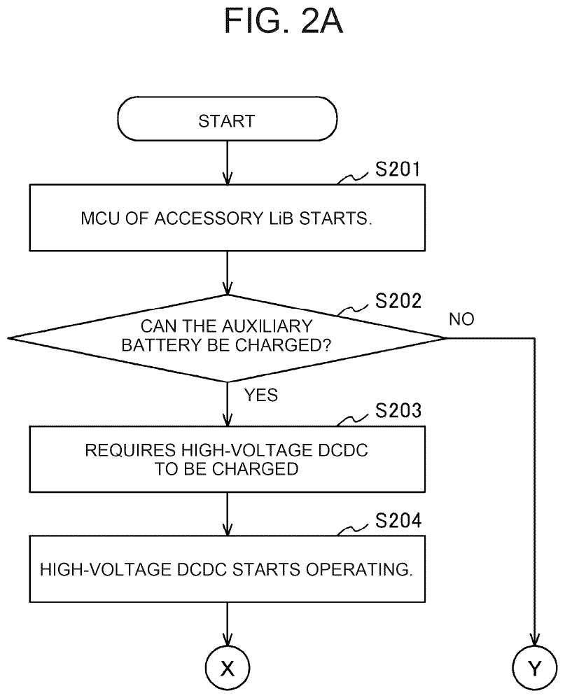

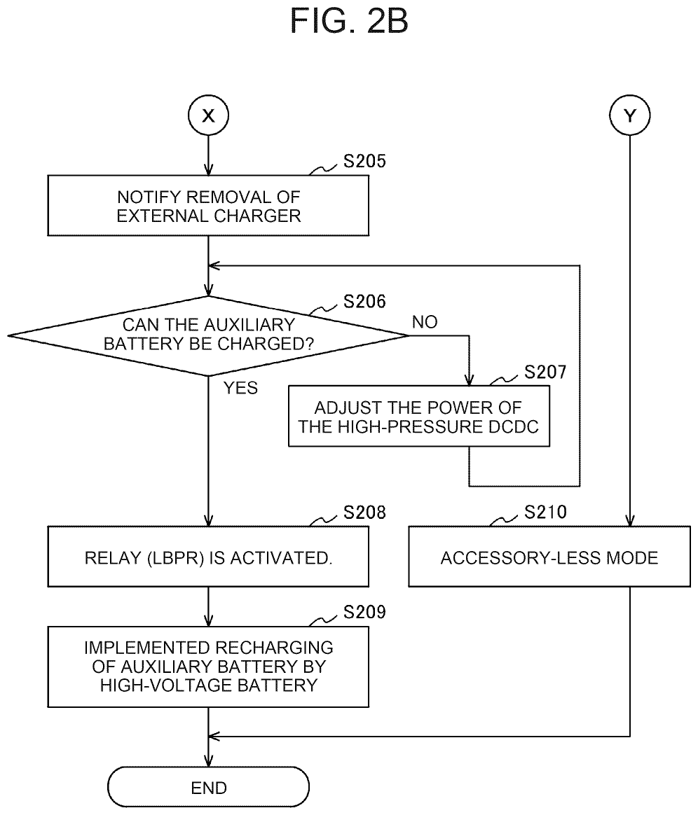

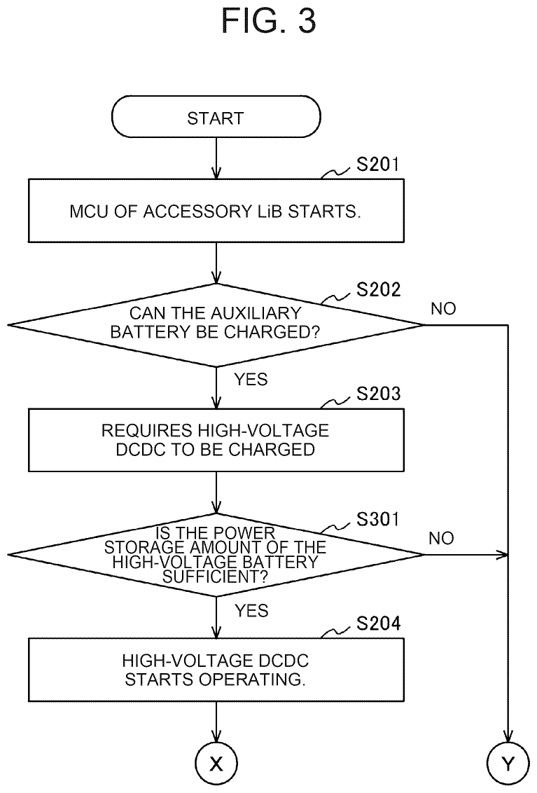

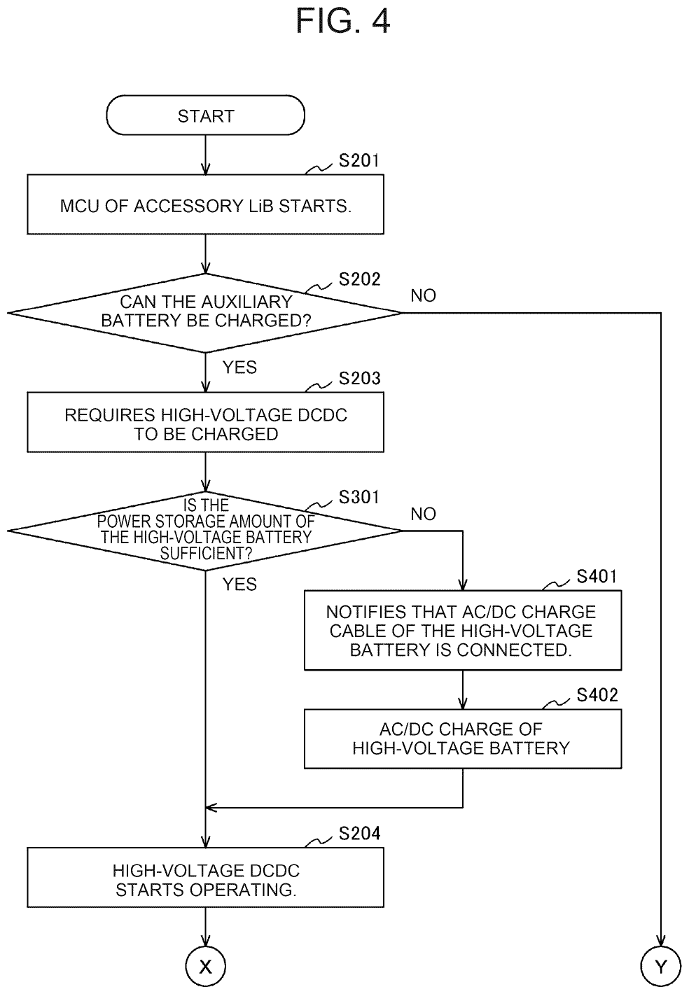

Next, the control performed by the battery control system 1 according to the present embodiment will be described with reference to FIG. 2A, FIG. 2B, FIG. 3 and FIG. 4.

### (1) First Example

FIG. 2A and FIG. 2B are flow charts illustrating the process of the charge control (first embodiment) by the jump start executed in the battery control system 1. The process of FIG. 2A and the process of FIG. 2B are connected by the couplers X and Y, respectively.

In the charge control by the jump start of the first embodiment shown in FIGS. 2A and 2B, relay (LBPR) 32 is shut off to protect the auxiliary battery 31 from over-discharge due to the long-term leaving of the vehicles. Further, when the external charger is connected to the external power supply terminal 60 in order to start the vehicle while the MCU 33 is stopped (sleep or shutdown), the operation is started.

### S201

MCU 33 of the auxiliary LiB 30 starts (wakes up). That is, the voltage (e.g., 12 V) of the external charger connected to the external power supply terminal 60 is applied to the power supply of MCU 33 through the relay 41 and the internal power supply 34, thereby activating MCU 33. The external charger is also energized to other ECU and loads (12 V systems) electrically connected to the external power supply terminal 60. When MCU 33 of the auxiliary LiB 30 is started, the process proceeds to S202.

### S202

MCU 33 of the auxiliary LiB 30 determines whether the auxiliary battery 31 is ready to be charged. This determination is made in order to suppress recharging of the auxiliary battery 31 which has a potential for copper elution at a voltage of a certain value or less. Specifically, MCU 33 determines whether or not the auxiliary battery 31 is in a chargeable condition based on whether or not the voltage of the auxiliary battery 31 acquired from the monitoring IC 35 exceeds a predetermined threshold. If the auxiliary battery 31 is ready to be charged (S202, Yes), the process proceeds to S203. On the other hand, if the auxiliary battery 31 is not rechargeable (S202, No), the process proceeds to S210.

### S203

MCU 33 of the auxiliary LiB 30 requires control to charge the auxiliary battery 31 with the electric power of the high-voltage battery 10 with respect to the high-voltage DCDC 20 (MCU 23). When the high-voltage DCDC 20 is required to charge the auxiliary battery 31, the process proceeds to S204.

### S204

The high-voltage DCDC 20 starts operation in response to a request from the auxiliary LiB 30. Specifically, the MCU 23 of the high-voltage DCDC 20 is outputted from the high-voltage DCDC 20 by controlling the operation of DCDC converter (DDC) 21 and converting the high voltage of the high-voltage battery 10 into a low voltage (for example, 12 V). When the operation of the high-voltage DCDC 20 starts, the process proceeds to S205.

### S205

The battery control system 1 notifies the user of the vehicle that has performed the jump start of an instruction to remove an external charger (not shown) from the external power supply terminal 60. When the removal notification of the external charger is performed, the process proceeds to S206.

### S206

The MCU 33 of the auxiliary LiB 30 determines whether or not the auxiliary battery 31 can be charged (pumped-out charge) by the output voltage of the high-voltage DCDC 20, that is, the voltage applied to the end of the relay 32 in the interrupted condition of the auxiliary LiB 30. This determination is made in order to confirm whether or not the voltage applied to the auxiliary battery 31 does not become an overvoltage (overvoltage detection). Typically, the output voltage of the high-voltage DCDC 20 is determined by whether or not the output voltage is less than a first threshold value, which is a voltage at which the auxiliary battery 31 becomes an overvoltage. This determination is also significant in the sense of suppressing the application of an overvoltage to the auxiliary battery 31 when the external charger is not removed from the external power supply terminal 60 despite the notification of S205. If the auxiliary battery 31 can be charged (S206, Yes), the process proceeds to S208. On the other hand, if the auxiliary battery 31 cannot be charged yet (S206, No), the process proceeds to S207.

### S207

The MCU 33 of the auxiliary LiB 30 lowers the voltage applied to the auxiliary LiB 30 by requesting the MCU 23 of the high-voltage DCDC 20 to adjust the output voltage of the DCDC converter (DDC) 21. When the output voltage of the high-voltage DCDC 20 is adjusted, the process proceeds to S206.

### S208

In MCU 33 of the auxiliary LiB 30, relay (LBPR) 32 is controlled to be in the on-state to electrically connect the high-voltage battery 10 and the auxiliary battery 31. Accordingly, a voltage capable of charging the auxiliary battery 31 is applied to the auxiliary battery 31. When the relay 32 is turned on, the process proceeds to S209.

### S209

The battery control system 1 performs charging (pumping charging) of the auxiliary battery 31 by the high-voltage battery 10. Therefore, the charging is performed while the power control (charging control) is performed by MCU 23 of the high-voltage DCDC 20. When the charging of the auxiliary battery 31 is completed, the charge control by the jump start of the first example is ended.

### S210

Since the auxiliary battery 31 cannot be charged by the high-voltage battery 10, the battery control system 1 terminates the charge control by the jump start of the first example in a state in which the auxiliary battery 31 is in the non-functional auxiliary device mode. In the accessory-less mode, for example, a notification prompting the user of the vehicle who has performed the jump start to replace the auxiliary battery 31 may be given.

According to the charge control by the jump start of the first example, when the vehicle is started by the jump start, it is possible to suppress recharging of the auxiliary battery 31 that has been completely discharged without being appropriately controlled. In addition, the auxiliary battery 31 can be protected from the overvoltage of the external charger.

### (2) Second Example

The charge control by the jump start of the second example executed in the battery control system 1 is obtained by adding a process of avoiding an unnecessary decrease in the power storage amount of the high-voltage battery 10 in the charge control by the jump start of the first example.

The charge control by the jump start of the second example is a flow chart obtained by replacing the process of FIG. 2A of the charge control by the jump start of the first example with the process of FIG. 3. In FIG. 3, the same steps as those in FIG. 2A are denoted by the same step numbers. Hereinafter, the charge control by the jump start of the second embodiment will be described mainly with respect to the process of FIG. 3, and the process of FIG. 3 and the process of FIG. 2B are connected by the couplers X and Y, respectively.

### S203

MCU 33 of the auxiliary LiB 30 requires control to charge the auxiliary battery 31 with the electric power of the high-voltage battery 10 with respect to the high-voltage DCDC 20 (MCU 23). When the high-voltage DCDC 20 is required to charge the auxiliary battery 31, the process proceeds to S301.

### S301

MCU 23 of the high-voltage DCDC 20 determines whether or not the power storage amount of the high-voltage battery 10 is sufficiently high. More specifically, MCU 23 determines whether or not the present storage amount of the high-voltage battery 10 is equal to or greater than a second threshold value that satisfies the smallest storage amount (allowable storage amount after charging) that is allowable for the power storage amount after being reduced by charging. In other words, it is determined whether or not the high-voltage battery 10 is not exhausted by charging the auxiliary battery 31. If the power storage amount of the high-voltage battery 10 is enough (S301, Yes), the process proceeds to S204. On the other hand, if the power storage amount of the high-voltage battery 10 is insufficient (S301, No), the process proceeds to S210.

According to the charge control by the jump start of the second example, in a situation where it is not desired to reduce the power storage amount in the high-voltage battery 10 more than necessary, the charge control by the jump start of the second example can be ended in a state in which the auxiliary battery 31 is in the non-functional auxiliary machine mode. Therefore, it is possible to suppress rising of the high-voltage battery 10.

### (3) Third Example

The charge control by the jump start of the third example executed in the battery control system 1 is obtained by adding a process of charging the high-voltage battery 10 in the charge control by the jump start of the second example, instead of immediately entering the auxiliary machine-less mode when the power storage amount in the high-voltage battery 10 is not sufficient.

The charge control by the jump start of the third example is a flow chart in which the processing of FIG. 3 of the charge control by the jump start of the second example is further replaced with the processing of FIG. 4. In FIG. 4, steps that perform the same process as in FIG. 2A and FIG. 3 are assigned the same step numbers. Hereinafter, the charge control by the jump start of the third embodiment will be described mainly with respect to the process of FIG. 4, and the process of FIG. 4 and the process of FIG. 2B are connected by the couplers X and Y, respectively.

### S301

MCU 23 of the high-voltage DCDC 20 determines whether or not the power storage amount of the high-voltage battery 10 is sufficiently high. If the power storage amount of the high-voltage battery 10 is enough (S301, Yes), the process proceeds to S204. On the other hand, if the power storage amount of the high-voltage battery 10 is insufficient (S301, No), the process proceeds to S401.

### S401

The battery control system 1 notifies the user of the vehicle that has performed the jump start to connect a cable for AD/DC charging the high-voltage battery 10 from an external power source. When AD/DC charging cable is connected, the charging port of the vehicle is opened after MCU 33 of the auxiliary LiB 30 is activated. When the connection of AD/DC charging cable is notified, the process proceeds to S402.

### S402

MCU 23 of the high-voltage DCDC 20 performs AD/DC charging of the high-voltage battery 10 from an external power source via a connected AD/DC charging cable. This charging is performed until the power storage amount of the high-voltage battery 10 becomes equal to or larger than the second threshold value (the power storage amount satisfying the allowable power storage amount after charging). A well-known method is used for AD/DC charge. When AD/DC charge of the high-voltage battery 10 is performed, the process proceeds to S204.

According to the charge control by the jump start of the third example, even when the power storage amount in the high-voltage battery 10 is small, the power storage amount in the high-voltage battery 10 can be recovered and the charge control by the jump start can be performed.

### Operations and Effects

According to the battery control system 1 according to the embodiment of the present disclosure described above, when the vehicle in which the power storage amount in the auxiliary battery 31 is reduced is started at the jump start, it is determined whether or not the auxiliary battery 31 is in a chargeable state. When the auxiliary battery 31 is in a chargeable state, the auxiliary battery 31 is charged with the electric power of the high-voltage battery 10, which is an output voltage that does not cause an overvoltage to the auxiliary battery 31, while adjusting the output voltage of the high-voltage battery 10.

By this control, it is possible to suppress the copper eluted from the negative electrode in the auxiliary battery 31 in the over-discharge state to be precipitated and to cause a short circuit of the electrode.

Although an embodiment of the present disclosure has been described above, the present disclosure is not limited to the above-described battery control system. The present disclosure can be regarded as a method executed by a battery control system including a processor and a memory, a program of the method, a computer-readable non-transitory recording medium storing the program, or a vehicle equipped with a battery control system.

The battery control system of the present disclosure can be used when it is desired to control charging and discharging of an auxiliary battery mounted in a vehicle.

What is claimed is:

1. A battery control system that controls charging by a jump start of an auxiliary battery in which a power storage amount is reduced, the battery control system comprising:
a first processing unit that determines whether or not the auxiliary battery is in a chargeable state;
a second processing unit that adjusts an output voltage of a high-voltage battery when the auxiliary battery is in the chargeable state; and
a third processing unit that charges the auxiliary battery with power of the high-voltage battery when the output voltage of the high-voltage battery becomes equal to or less than a first threshold.

2. The battery control system according to claim 1, wherein the first threshold is a voltage at which the auxiliary battery becomes an overvoltage.

3. The battery control system according to claim 1, wherein:
the second processing unit controls the output voltage of the high-voltage battery via a DCDC converter in a state where a relay connecting the auxiliary battery and the high-voltage battery is electrically disconnected; and
when the output voltage of the high-voltage battery becomes less than the first threshold, the third processing unit electrically conducts the relay to charge the auxiliary battery with power of the high-voltage battery.

4. The battery control system according to claim 3, wherein when a power storage amount of the high-voltage battery is less than a second threshold, the third processing unit does not perform charging of the auxiliary battery while the relay is disconnected.

5. The battery control system according to claim 3, wherein:
a device that is able to perform charging from an external power source is connected to the high-voltage battery; and
when a power storage amount of the high-voltage battery is less than a second threshold, the third processing unit charges the high-voltage battery by the device until the power storage amount of the high-voltage battery becomes equal to or more than the second threshold, and thereafter the third processing unit electrically conducts the relay to charge the auxiliary battery with power of the high-voltage battery.

6. The battery control system according to claim 4, wherein the second threshold is a power storage amount of the high-voltage battery that is able to supply power for charging of the auxiliary battery.

7. The battery control system according to claim 5, wherein the second threshold is a power storage amount of the high-voltage battery that is able to supply power for charging of the auxiliary battery.
